(19) United States
(12) Patent Application Publication
(10) Pub. No.: US 2010/0161994 A1
(43) Pub. Date: Jun. 24, 2010

(54) METHOD AND APPARATUS FOR AUTHENTICATING STATIC DATA CARRIERS

(75) Inventors: Javier Serret Avila, Brussels (BE); Wim Ton, Edinburgh (IE); Philippe Teuwen, Leuven (BE); Pim Theo Tuyls, Eindhoven (NL); Marijke G.C.S. De Soete, Oostkamp (BE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/293,567

(22) PCT Filed: Mar. 15, 2007
(86) PCT No.: PCT/IB07/50886

§ 371 Date: Sep. 19, 2008

(30) Foreign Application Priority Data
Mar. 21, 2006 (EP) 06111508.5

(51) Int. Cl. G06F 12/14

(52) U.S. Cl. 713/189

(57) ABSTRACT

Method of authenticating optical discs (10) to a rendering device (50), wherein the disc (10) comprises media content (90), a second database (80) with second authentication data (81) and a transponder (30), the method comprising the steps of: a) Receiving a challenge (C1) from a rendering device (50) by the transponder (30), b) Determining a response (R1) to the challenge (C1) by the transponder (30), and c) Sending the response (R1) to the rendering device (50) by the transponder (30).

### FIELD OF THE INVENTION

The invention relates to a method and an apparatus for authenticating static data carriers. Typical static data carriers, e.g. CDs or DVDs nowadays do not include any specific provisions to detect counterfeiting, with respect to an essentially synchronous entry of the static data carrier to market. This has proven a weak protection and specific efforts have been introduced to include anti-counterfeiting means in newer ROM disc standards, such as PlayStation 2 or XBOX. However, these means still relying on a technology, once well understood, can easily be replicated. Usually, this results in exact copies of the content made available through alternative unauthorized networks.

Furthermore, in typical current sales and rental scenarios for static media, there are barely secure methods to safeguard the static media against counterfeiting or other forms of misuse. This can result in a significant disruption of business, because unauthorized copies of the content are made available through alternative, unauthorized channels of distribution.

The static data carriers are designed to be mass-produced in a highly efficient process, which is mainly based on a pressing of a master on a blank. This pressing process is entirely physical and, once well understood, fairly easy to replicate. As a result, even ROM disc specifications including “hidden” information cannot withstand counterfeiting for long periods of time. Furthermore, it is well known to include visually appealing holograms for some pieces of content. These holograms are harder to replicate, but still subject to a difficult validation.

### BACKGROUND OF THE INVENTION

Hence, it is an object of the invention, to provide an improved authentication method for static data carriers, which is harder to overcome by unauthorized means.

OBJECT AND SUMMARY OF THE INVENTION

The object of the invention is achieved by methods according to the claims 1, 2, 3, 15, 16 and 17.

The object of the invention is furthermore achieved by an optical disc according to claim 25. Preferred embodiments of the invention are defined in dependent claims.

The aspects of the invention are apparent from and will be elucidated with reference to the embodiments described hereinafter.

### BRIEF DESCRIPTION OF THE DRAWINGS

The invention will be described in greater detail hereinafter, by way of non-limiting examples, with reference to the embodiments shown in the drawings:

FIG. 1 shows a generalized message flow according to the present invention.

FIG. 2 shows in principle an overview of an enabling device according to the present invention.

FIG. 3 shows in principle a preferred embodiment of an authentication procedure according to the present invention.

FIG. 4 shows in principle a further preferred embodiment of an authentication procedure according to the present invention.

FIG. 5 shows in principle an overview of a rendering device according to the present invention.

FIG. 6 shows in principle a further preferred embodiment of an authentication procedure according to the present invention.

FIG. 7 shows in principle a further preferred embodiment of an authentication procedure according to the present invention.

FIG. 8 shows in principle a further preferred embodiment of an authentication procedure according to the present invention.

The object of the present invention is achieved by a method of authenticating optical discs to a rendering device, wherein the disc comprises media content, a second database with second authentication data and a transponder, the method comprising the steps of:
a) Receiving a challenge Cl from a rendering device by the transponder,
b) Determining a response R1 to the challenge Cl by the transponder, and
c) Sending the response RI to the rendering device 50 by the transponder 30.

By means of the method according to the invention it is advantageously possible to manage the optical discs securely. That is, for example, a distribution and handling of media contents of the optical discs can be handled in a predetermined manner. Any unauthorized usage of the optical discs can therefore be reduced significantly.

A further aspect of the invention is a method of authenticating optical discs with media content by means of an enabling device and a first database with first authentication data, wherein the optical disc further comprises a transponder. The method comprises the following steps:
a) Reading and decrypting the first authentication data by the enabling device,
b) Requesting a challenge from the transponder by the enabling device,
c) Sending the challenge to the enabling device by the transponder,
d) Finding a response to the challenge in the first authentication data by the enabling device,
e) Sending the response to the transponder by the enabling device,
f) Determining a response to the challenge by the transponder, and
g) Checking by the transponder whether the responses match each other.

Therefore, by means of the inventive method, the first authentication data arranged in a first database and a response to a challenge, wherein the response is calculated by the transponder, have to match up in order to prove an authenticity status of the optical disc. That is, the first authentication data arranged in the first database and authentication data arranged on the transponder have to match up in order to verify an authenticity status of the optical disc. The authenticity of the optical disc ensures that the optical disc is not a counterfeited one or has otherwise been placed to market by any unauthorized means.

The object of the invention is further achieved by a method of authenticating optical discs with media content to a rendering device, wherein an optical disc comprises a media content, a second database with second authentication data and a transponder. The inventive method comprises the following steps:
a) Reading and decrypting the second authentication data by the rendering device, wherein a set of the authentication data comprises at least a challenge and a response to the challenge,
b) Sending a challenge from a set of the authentication data to the transponder by the rendering device,
c) Determining a response to the challenge by the transponder,
d) Sending the response to the rendering device by the transponder, and
e) Checking whether the response matches the challenge from the second authentication data that have been decrypted in step a) by the rendering device.
   That is, by means of the inventive method, an authentication database which is arranged on the optical disc and authentication data which are arranged on the transponder have to match up in order to ensure an authenticity of the optical disc. Resulting therefrom, advantageously, a counterfeiting or other misuse of the optical disc is hampered as far as possible.

The object of the present invention is further achieved by an optical disc comprising a media content and a second data base with second authentication data, wherein the optical disc further comprises a transponder, and wherein at least a subset of authentication data on the transponder matches cryptographically at least a subset of the second authentication data.

By means of the optical disc according to the present invention, it is advantageously possible to support an authentication procedure of the optical disc by means of an authentication database which is arranged on the optical disc. Furthermore, the authenticity of the optical disc is supported by means of authentication data of a transponder which are arranged on the optical disc, wherein the authentication data in the database and the authentication data on the transponder have to match up cryptographically.

### DESCRIPTION OF EMBODIMENTS

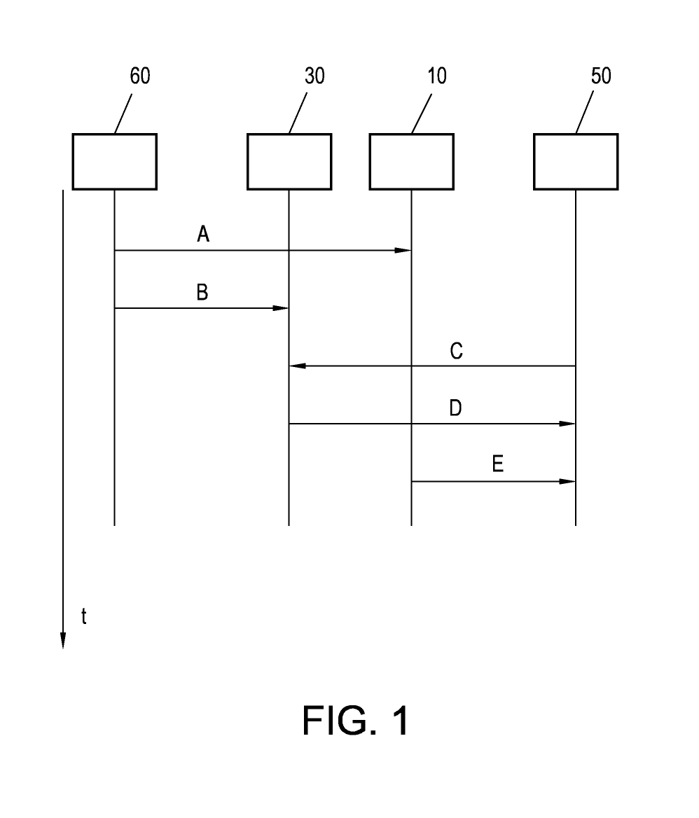

FIG. 1 shows a generalized message flow between inventive components in order to illustrate a basic concept of the present invention. FIG. 1 shows in principle an authorizing means 60, a transponder 30 being arranged on an optical disc 10 and a rendering device 50 being capable of rendering a media content 90 (not shown in FIG. 1) of the optical disc 10. On a left-hand side of FIG. 1 there is shown a time axis, in order to illustrate a lapse of time t.

Firstly, in a step A, the authorizing means 60 (which can be added and/or replaced by distributing means 70 or any other licensing means) supply an encrypted media content 90 to the optical disc 10. Afterwards, the optical disc 10 is physically distributed well before an official release date of the media content 90 of the optical disc 10. Thereafter, in a step B, the authorizing means 60 deliver a cryptographic key to the transponder 30 on the optical disc 10. The delivery of the cryptographic key to the transponder 30 is preferably performed on an official release date of the optical disc 10. In a step C, the rendering device 50 requests the cryptographic key from the transponder 30, whereupon the transponder 30, in a step D, delivers the cryptographic key to the rendering device 50. In a step E, the rendering device 50 uses the cryptographic key to decrypt the media content 90. The cryptographic key, as described above, can be formed as a content key, which is used to decrypt the media content 90. A rendering device 50, not being in a possession of the content key, is therefore not capable of decrypting and rendering the media content 90. As described, a chronological order of the steps A, B, C, D and E of FIG. 1 has some meaning for the present invention.

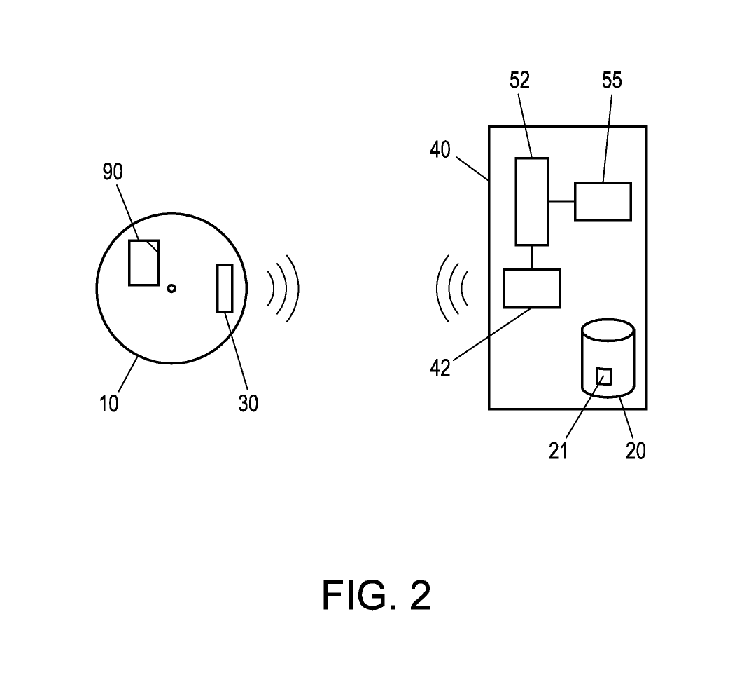

FIG. 2 shows in principle enabling components according to the present invention. “Enabling” in the context of the present invention means that the optical disc 10 is enabled for a rendering process by the rendering device 50. FIG. 2 only shows elements which are within the context of the present invention in order to enhance comprehensibility. As already mentioned above, the optical disc 10 comprises a media content 90 (e.g. in the form of titles, films, audio and/or videoclips and so on) and a transponder 30. The transponder 30 can, for example, be an RFID-tag which can be sticked, glued or otherwise integrated with the optical disc 10. The transponder 30 comprises authentication data (not shown in FIG. 2), which are delivered to the transponder 30 by the authorizing means 60. The transponder 30 can then be read and/or written to efficiently by appropriate devices in order to realize the present invention. In a right-hand section of FIG. 2, there is shown an enabling device 40, which in the context of the present invention is intended to “enable” a rendering of the media content 90 on the optical disc 10 by means of the rendering device 50 (not shown in FIG. 2). Thus, without an impact of the enabling device 40 to the optical disc 10, the optical disc 10 would not be capable of being rendered by the rendering device 50. The enabling device 40 comprises a first database 20, with first authentication data 21. Needless to say, that though the first database 20 in FIG. 2 is shown as being integrated with the enabling device 40, the first database 20 could also be arranged separately from the enabling device 40. In this case, a physical connection to the enabling device 40 would be necessary. Furthermore, in a preferred embodiment, the first database 20 can advantageously be realized as an encrypted authentication database, which is delivered to the enabling device 40 by the authorizing means 60 or the distributing means 70 or any other means which are capable of distributing the media-content 90. The first authentication data 21 can be embodied as a set of enabling records (E-records), wherein each of the enabling records comprises at least three items:
a challenge,
a response, which is a result of applying a cryptographic algorithm to the challenge using a transponder key KRFID of the transponder 30 which is only known to the transponder 30, and
an encrypted content key KENCR, which is obtained by an encryption of a content key KCONT with a session key KSESS. The encrypted content key KENCR is determined by the authorizing means 60 and is written to the first database 20 by the authorizing means 60. Each proper subset of the enabling records (E-records) can only be accessed by means of only one dedicated secret enabling key KENAB on the enabling device 40.

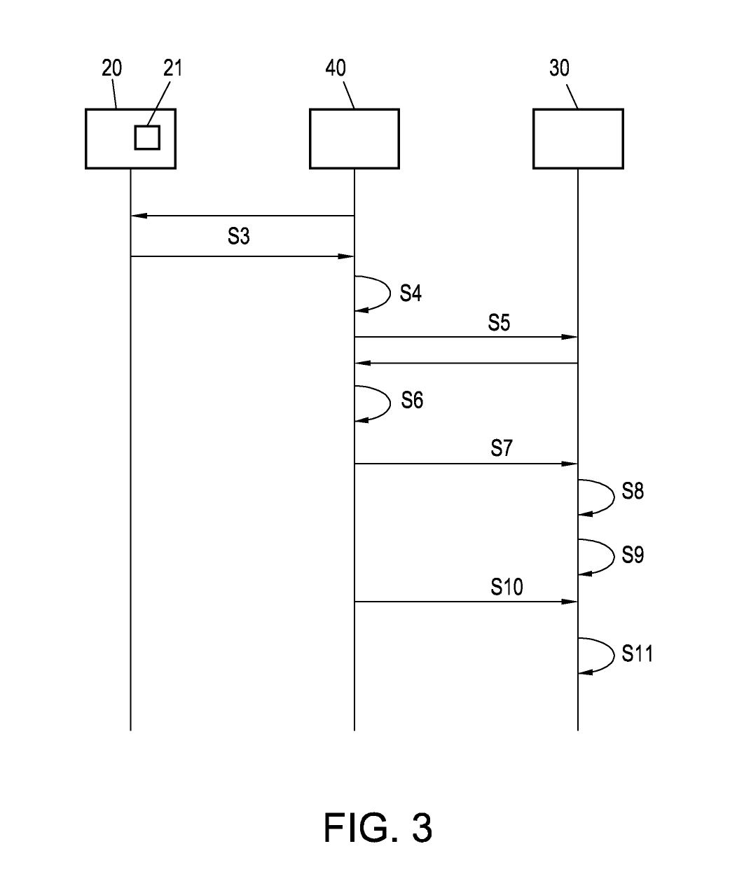

Furthermore, the enabling device 40 comprises an RFID writing device 42, which is capable and intended to communicate to the transponder 30 on the optical disc 10 wirelessly. The enabling device 40 furthermore comprises a control unit 52 (embodied for example as a microprocessor which is intended to control all of the items of the enabling device 40) and an optical display 55, which is capable of signalizing any kind of information to a user of the enabling device 40. FIG. 3 shows in principle a message flow between the items as described with respect to FIG. 2. Several messages are exchanged between the first database 20 with the first authentication data 21, the enabling device 40 and the transponder 30 on the optical disc 10. In a step S3, the enabling device 40 reads from the first database 20 a subset of the first authentication data 21 (E-records). In a step S4, the enabling device 40 decrypts the enabling records by means of the enabling key KENAB, which is preferably shared between the authorizing means 60 (not shown in FIG. 2) and the enabling device 40. The enabling key KENAB is generated by the authorizing means 60 and has essentially two functions: Firstly, to protect the first database 20 from unauthorized access. Second, to provide a possibility to revoke enabling devices 40 from an enabling functionality of the optical discs 10. For example, if the authorizing means 60 wants to revoke a specific enabling key KENAB, it could send all non-revoked enabling devices 40 new enabling keys KENAB. Needless to say, that either multiple enabling devices 40 can be provided with an identical enabling key KENAB or that each enabling device 40 is provided with a different, unique enabling key KENAB. The new enabling key KENAB could then be used for future releases of the first database 20. Thus, the revoked enabling keys KENAB will no longer be capable of decrypting any subsequent releases of the first database 20. In a step S5, the enabling device 40 requests a challenge from the transponder 30 and, as a result thereto, receives from the transponder 30 a challenge from authentication data on the transponder 30.

In a step S6, the enabling device 40 looks up the received challenge in the subset of the first authentication data 21, the first authentication data 21 having been decrypted in step S4. In a step S7, the enabling device 40 sends the response, which the enabling device 40 has found in the subset of the first authentication data 21 which matches the challenge to the transponder 30 as received in step S5. In a step S8, the transponder 30 processes the challenge with the transponder key KRFID in order to obtain a response to the challenge. In the step S8, the transponder 30 further checks if the received response from the enabling device 40 matches the response as calculated in step S8. If the responses match up, the transponder 30 redeems the enabling device 40 as authentic for the optical disc 10. In more detail, in step S8, the transponder 30 calculates the response by applying a first cryptographic algorithm to the challenge by using the transponder key KRFID. Mathematically, this can be expressed as follows: response=f1(KRFID, challenge)

In a step S9, the transponder 30 determines a session key KSESS by applying a second cryptographic algorithm to the challenge by again using its transponder key KRFID. Mathematically, this can be expressed as follows: KSESS=f2(KRFID, challenge) The session key KSESS is used to transport the content key KCONT securely from and to the transponder 30. In a step S10, the enabling device 40 sends an encrypted content key KENCR to the transponder 30. Afterwards, in a step S11, the transponder 30, in order obtain the content key KCONT, applies a cryptographic algorithm to the encrypted content key KENCR using the session key KSESS as having been determined in step S9. Finally, in a step S11, the decrypted content key KCONT is stored on the transponder 30 and is ready to be accessed in a subsequent rendering procedure of the optical disc 10.

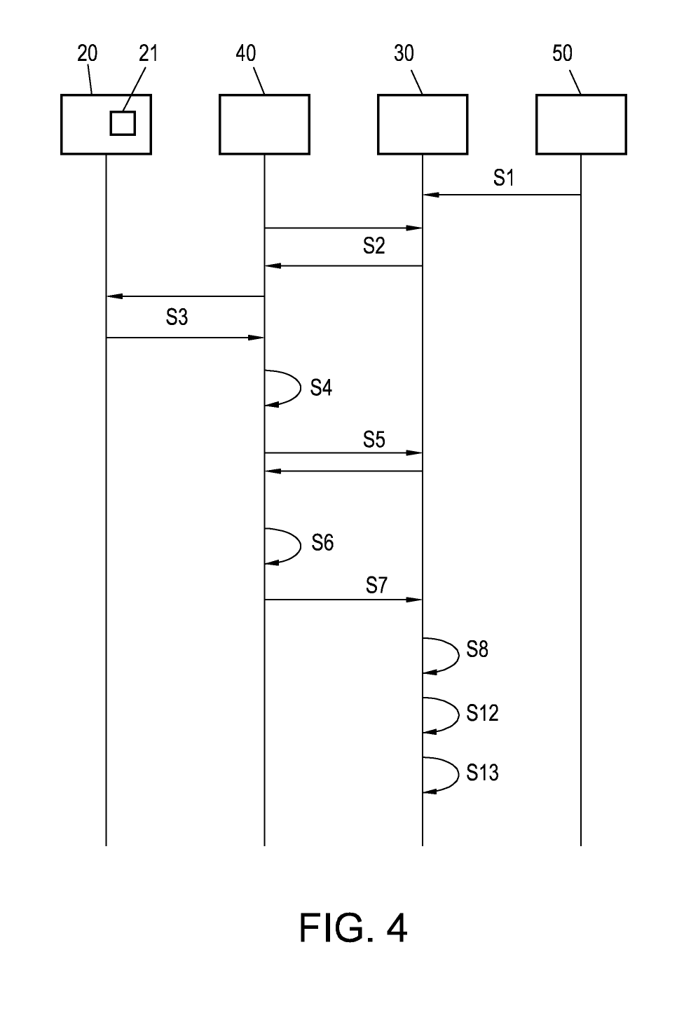

FIG. 4 shows a further preferred embodiment of a method according to the present invention. In order to improve readability, method steps which are identical or similar to method steps of FIG. 3 are indicated by identical reference numerals. In a step S1 the transponder 30 gets data specifying a rendering process of the optical disc 10 (e.g. an amount of a playtime) from the rendering device 50. In a step S2, the enabling device 40 requests and gets the rendering data from the transponder 30. The proximate steps S3 to S8 are identical as far as possible to the steps S3 to S8 described with respect to FIG. 3. Therefore, a detailed description of these steps is omitted hereinafter. In a step S12, the transponder 30 resets the rendering data of the rendering device 50. In a step S13, the transponder 30 applies a cryptographic algorithm to the challenge in the transponder 30 in order to obtain a new challenge for the next session of this embodiment of the inventive method.

An advantageous application of the embodiment as described with respect to FIG. 4 is, for example, an update of media usage patterns under more or less real time conditions. To this end, the transponder 30 serves e.g. as a “usage counter”, which can be read back and written to at a point-of-sale in any media-return request. Due to the fact, that the transponder 30 can be easily read/written at distance by appropriate devices, said devices can execute this operation very efficiently. This allows a buyer of the optical disc 10 to demonstrate that the media content 90 of the optical disc 10 was indeed never played or was only played for a very short time (e.g. enough for the buyer to make a “non-view” decision). Once an optical disc 10 has been returned at a point-of-sale, the point-of-sale will use its own RFID reading device 41 (not shown in FIG. 4) to “reset” the usage counter on the transponder 30, thus supporting a transparent process for putting the optical disc 10 back for sale.

The resetting of the rendering data as described with respect to step S12 can for example be performed if the rendering data exceed a certain threshold value. In this way, the present invention provides efficient means to report and to process usage patterns for a usage of static media. To this end, the rendering device 50 increases the rendering data (e.g. a playtime of the optical disc 10 or an indicated list of titles of the optical disc 10) on the transponder 30 at essential regular intervals while rendering the optical disc 10. If a customer returns the optical disc 10, the retailer will read the rendering data, and if they are below a certain threshold, the retailer has proof that the customer played only a small part (or nothing) of the optical disc 10. The retailer may then decide on a refund or allow the customer to exchange the returned optical disc 10 for another item. The retailer then resets the usage counter to zero after an authentication process.

The first database 20 from FIG. 4 can, e.g., be embodied as an encrypted authentication database which is delivered to the enabling device 40 by the authorizing means 60 or any content owner of the media content 90 of the optical disc 10. The whole first database 20 can furthermore be cryptographically signed (e.g. RSA) by a licensing authority.

The first authentication data 21 can be embodied as a set of enabling records (E-records), wherein each of the enabling records can contain at least two items:
a challenge, and
a response, which is a result of applying a cryptographic algorithm to the challenge using a secret key KRFID, which is only known to the transponder 30. Furthermore, each proximate challenge can be calculated by applying a cryptographic algorithm to the previous challenge. For each proper subset of the enabling records, only one enabling device 40 having a matching secret key KENAB can access this subset. Furthermore, it is possible for the authorizing means 60, according to step B of FIG. 1, to write different challenges from the set of enabling records (E-records) of the first authentication data 21 to each of the transponders 30. In this way, a licensing authority can manage an issuance and a delivery of the secret keys KRFID and KENAB. This could be executed in full directly by the authorizing mean 60 or through other stakeholders in a value chain (e.g. content owners of the media contents 90).

In a further preferred embodiment of the inventive method, the rendering device 50 increases the rendering data of the transponder 30 at essentially regular intervals while rendering the optical disc 10. The rendering device 50 reads the rendering data from the transponder 30. If the rendering data have reached a certain defined threshold, the rendering device 50 stops the rendering of the optical disc 10 with the media content 90. When a customer rents the optical disc 10, the retailer resets this value, thus enabling optical disc 10 to be played again.

In a further preferred embodiment of the present invention the rendering device 50 increases the rendering data on the transponder 30 at essentially regular intervals while playing the optical disc 10. If the rendering data have reached a certain threshold value, the transponder 30 erases the content key KCONT, thus preventing the rendering device 50 from further rendering the optical disc 10. In a case where the customer wants to rent the optical disc 10, the retailer restores the content key KCONT and resets the rendering data, thus enabling the optical disc 10 to be played again.

In a further preferred embodiment of the present invention, the rendering device 50 sends an identification to the transponder 30 during a rendering process of the optical disc 10. The transponder 30 is thus able to count a number of different rendering devices 50. If said number has reached a certain threshold value, the rendering device 50 can stop the rendering process of the optical disc 10. When a customer wants to rent the optical disc 10, the retailer resets the player counter described above, thus enabling the optical disc 10 to be played again.

In a further preferred embodiment of the present invention, the rendering device 50 sends an identification to the transponder 30 during the rendering of the optical disc 10. The transponder 30 will count the number of different player identifications it has received from different rendering devices 50. If said number of rendering devices 50 has reached a certain threshold, the transponder 30 is able to erase the content key KCONT, thus preventing the rendering device 50 from further rendering the optical disc 10 with the media content 90. When the customer rents the optical disc 10, the retailer is able restore the content key KCONT and reset the player counter, thus enabling the optical disc 10 to be played again.

A favorable case of use of the described preferred embodiments of the inventive method could be e.g. a scenario where an optical disc 10 is manufactured “for sale only”. That is to say, the transponder 30 will keep track of how many different rendering devices 50 have accessed the optical disc 10. In this way a playability of the optical disc 10 can be limited to a defined, restricted number of rendering devices 50. This will preclude or at least strongly discourage a usage of these optical discs 10 “for sale only” in rental operations. Similarly, when an optical disc 10 is manufactured “for rental only”, its transponder 30 will keep track of how many different rendering devices 50 access it after every check-out operation, thus limiting a number of rendering devices 50 to a few number of items. This will force rental operations to perform check-in/check-out operations which can optionally be linked to a backend-reporting-infrastructure, thus enabling content owners to keep accurate track of rental events. Furthermore, if the rental store decides to perform a stock clearance and to change an optical disc 10 for definitive “sale only” use, the last check-out at the rental store can be modified such that the transponder 30 is irreversibly updated with the new usage-policy (“for sale only”).

Another favorable case of use of the discussed preferred embodiments of the inventive method could be the following. Due to the fact that the transponders 30 can be easily communicated to, it is possible that the information on the transponder 30 can be updated at the point-of-sale during a purchasing operation. Equally, it is possible to perform a similar process during check-in/check-out operations in rental operations. In this fashion, when the optical disc 10 is initially released, its associated transponder 30 will include signalling information marking it “not valid” for rendering, or omitting information making it not useable. At the point-of-sale, a sales clerk will activate the optical disc 10 by writing missing information (e.g. the content key KCONT) to the transponder 30. If an optical disc 10 is stolen from the shelf, it will therefore advantageously still remain in the invalid state and any complainant rendering device 50 will refuse to play or will be unable to play the stolen optical disc 10.

Similarly, in rental operations, optical discs 10 are marked invalid in the check-in operation and then just made available to all customers in the stores. This obliterates the need to store the optical disc 10 away from a customers reach. The transponders 30 can be communicated to at the stores e.g. by hand-held or static RFID/NFC reading devices 41. Furthermore, the transponder 30 can be communicated to at the store desk's by the static or hand-held RFID/NFC reading devices 41 during check-in/check-out operations. The transponder 30 can be communicated to inside the rendering device 50 while the optical disc 10 is played during normal playing operations. Advantageously, most of the inventive preferred embodiments as described above do not need any external connection (e.g. via networking means) to either the authorizing means 60, the distributing means 70 or any other licensing means. Rather, with the present invention it is advantageously possible, that the optical discs 10 can be authenticated only locally by means of a local authentication infrastructure.

A further favorable case of use of the present invention is the following: At an official release date of the optical disc 10, missing information, for example in the form of content KCONT, is made available to all dedicated points-of-sale through qualified means, typically in the form of an internet service access on request by the point-of-sale. At the moment of the check-out or at any time after the official release date but previous to the purchase operation, the transponder 30 on the optical disc 10 is updated with missing data (e.g. the content key KCONT). Afterwards, at the customers home, a rendering device 50 of the customer detects that some information on the optical disc 10′ is absent. Hence, the rendering device 50 reads the transponder 30 and gets the content key KCONT. In this way, the optical disc 10 can be rendered by the rendering device 50 of the customer.

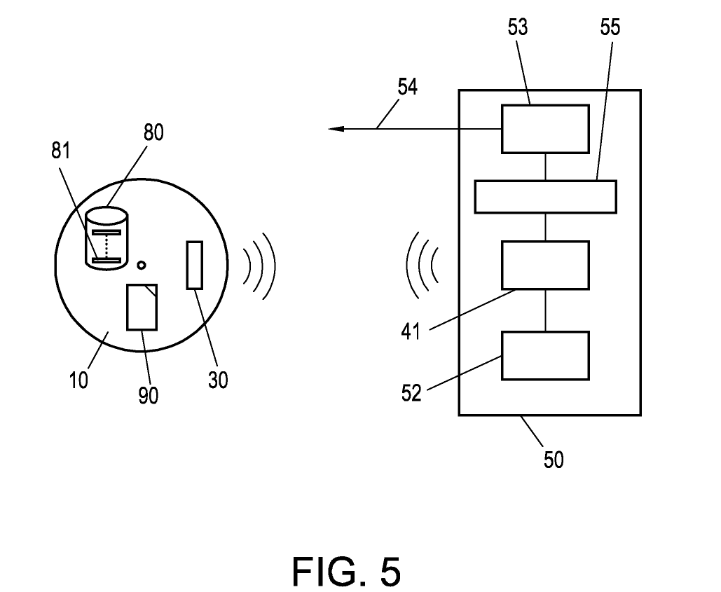

FIG. 5 shows in principle an overview of components by means of which the present invention can be realized. The optical disc 10 comprises, in addition to the previous preferred embodiments, a second database 80 with second authentication data 81. The second authentication data 81 can be embodied for example in the form of authentication records (A-records). Furthermore, the optical disc 10 can comprise media content 90 and, again, a transponder 30. A rendering device 50, shown in a right-hand section of FIG. 5 comprises a RFID reading device 41 which is able to communicate wirelessly with the transponder 30 on the optical disc 10. Furthermore, the rendering device 50 comprises a calculation unit 52 (e.g. embodied as microprocessor), a display 55 (in order to signalize information to a user of the rendering device 50) and drive electronics 53 which control a laser 54 for optically scanning the optical disc 10. Needless to say, that the aformentioned items are connected electrically in order to provide the necessary functionalities of the rendering device 50.

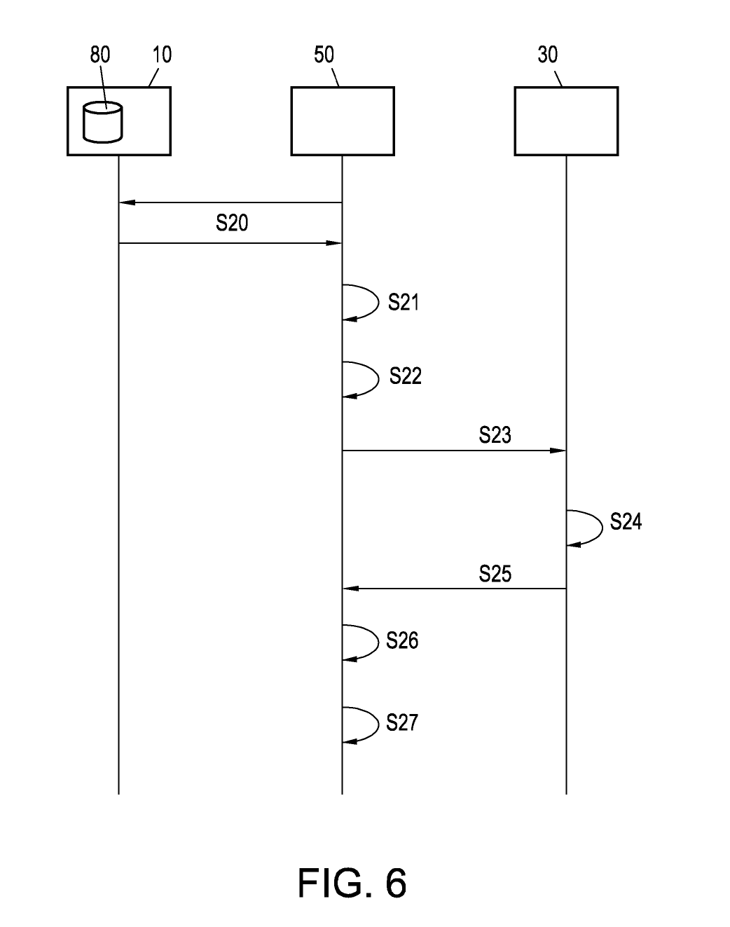

FIG. 6 shows a further preferred embodiment of an authentication method according to the present invention. The authentication procedure takes place between the rendering device 50, the transponder 30 and the optical disc 10 with the second database 80. In this embodiment, the optical discs 10 will be released with the media content 90 and the second database 80, embodied preferably as an encrypted authentication database. The second database 80 can be cryptographically signed (e.g. RSA) by a licensing authority, and can optionally be bound to the rest of the media content 90 via a secure content digest (for example SHA-1). The second authentication data 81 can preferably be embodied as a subset of authentication records (A-records), wherein each of the authentication records comprises at least two items:
a challenge, and
a response, which is the result of applying a cryptographic algorithm to the challenge using the transponder key KRFID, which transponder key KRFID is only known to the transponder 30. For each proper subset of the second authentication data 81, only one specific driver key KDRIV can access this subset. The authorizing means 60, e.g. in the form of a licensing authority, is able to manage an issuance and a delivery of both secret keys KRFID and KDRIV to the transponder 30 and to the rendering device 50, respectively. This could be executed in full directly by the authorizing means 60 or could be delegated through other stakeholders in the value chain, for example manufacturers of the rendering devices 50. Resulting therefrom, only a licensed rendering device 50 with a proper driver key KDRIV would be able to read and decipher e.g. at least a subset of an encrypted list of records of the media content 90 of the optical disc 10.

FIG. 6 shows in principle that in a step S20, the rendering device 50 reads from the optical disc 10 a subset of the second authentication data 81 on the second database 80. Afterwards, in a step S21, the rendering device 50 decrypts the subset of the second authentication data 81 (A-records) by means of its specific driver key KDRIV. The respective driver key KDRIV has been delivered to the rendering device 50 previously by the authorizing means 60. In a step S22, the rendering device 50 selects randomly an authentication record from the set of authentication records of the second authentication data 81 and, in a step S23, sends a challenge from the randomly selected authentication records to the transponder 30. The transponder 30, in a step S24, determines a response to the challenge by applying a cryptographic algorithm to the challenge by using its specific transponder key KRFID.

Afterwards, in a step S25, the transponder 30 sends the calculated response to the rendering device 50. In a step S26, the rendering device 50 checks whether the calculated response from the transponder 30 matches the response as having been randomly selected in previous step S22. If the two responses match up, the rendering device 50 confirms the transponder 30 on the optical disc 10 as authentic. Hence, the rendering device 50, in a step S27, displays a message “optical disc authentic” by means of the display 55 of the rendering device 50. Therefore, a user of the rendering device 50 has an efficient means to be informed of an authenticity status of the optical disc 10 inside the rendering device 50.

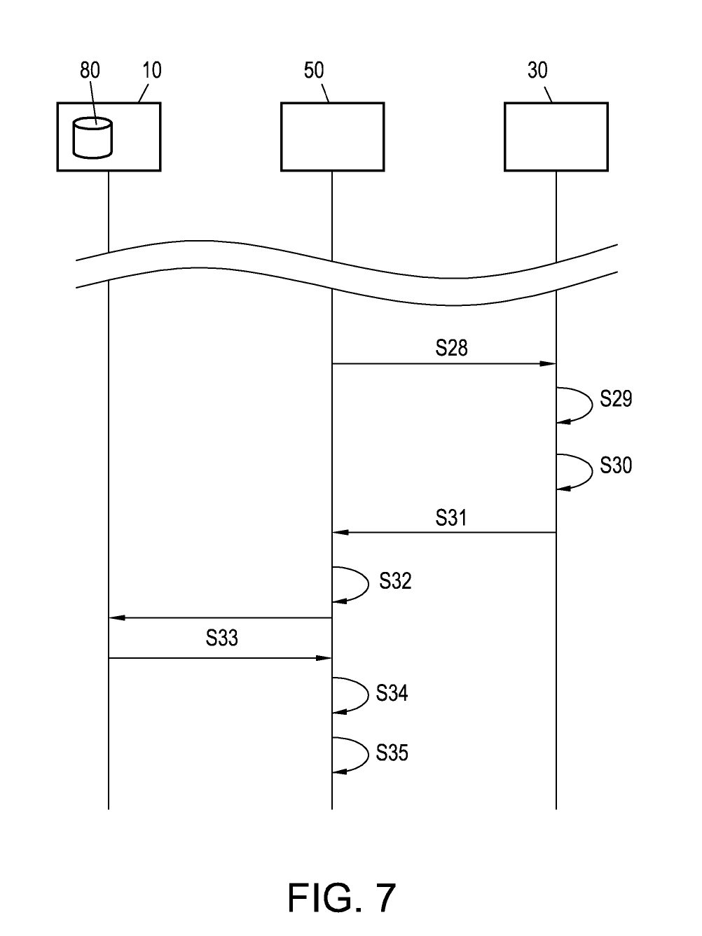

FIG. 7 shows a further preferred embodiment of an inventive authentication method. Here, the optical disc 10 contains an encrypted media content 90 (not shown in FIG. 7) and the second database 80 can preferably be formed as an authentication database with authentication records (A-records) having at least the three following items:
a challenge,
a response, which is the result of applying a first cryptographic algorithm to the challenge using the specific transponder key KRFID, which is only known to the transponder 30, and
a session key KSESS, which is the result of applying a second cryptographic algorithm to the challenge using the transponder key KRFID. The session key KSESS can be used to encrypt the content key KCONT, which in turn can be used to decrypt the encrypted media content 90 on the optical disc 10. In FIG. 7 only additional steps to the steps of FIG. 6 are shown. In an upper part of FIG. 7, for the sake of enhanced readability, there are not shown any procedure steps, as these performed steps are very similar to the steps S20 to S27 which have been described in connection with FIG. 6.

In a step S28, the rendering device 50 requests the content KCONT from the transponder 30. As a result of this request, the transponder 30, in a step S29 firstly determines the session key KSESS by applying the second cryptographic algorithm to the challenge using the transponder key KRFID. Mathematically, said application of the second cryptographic algorithm can be expressed as follows: KSESS=f2(KRFID, challenge)

Afterwards, in a step S30, the transponder 30 calculates an encrypted content key KENCR by applying a third cryptographic algorithm to the session key KSESS (as has been determined in step S29) and to the content key KCONT. The content key KCONT is stored unencrypted on the transponder 30 and is used by the rendering device 50 in order to decrypt the media content 90 for playback. Afterwards, in a step S31, the transponder 30 sends the encrypted content key KENCR to the rendering device 50. In a step S32, the rendering device 50 determines the content key KCONT by applying a fourth cryptographic algorithm to the session key KSESS and to the encrypted content key KENCR (as having been received in previous step S31). In a step S33, the rendering device 50 reads the encrypted media content 90 and an intended content list from the second database 80 on the optical disc 10. In a step S34, the rendering device 50 determines the decrypted media content 90 by applying a fifth cryptographic algorithm to the encrypted media content 90 using the content key KCONT. Finally, in a step S35, the rendering device 50 displays the media content 90 by means of the display 55. It should be noted that the aforementioned third and fourth cryptographic algorithms are preferably identical.

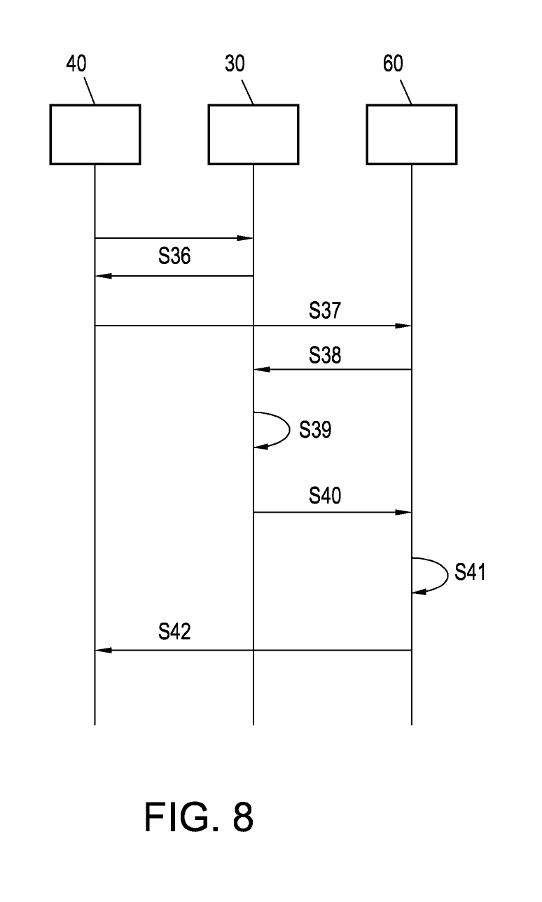

FIG. 8 shows a further preferred embodiment of an authentication procedure according to the present invention, which is performed between the enabling device 40, the transponder 30 and the authorizing means 60. In this embodiment, the transponder 30 and the optical disc 10 are very similar to those of the embodiments as have been described with respect to the FIGS. 5, 6 and 7. Firstly, in a step S36, the transponder 30 is read by the enabling device 40. This can be done, for example at a sales/rental-store or in any other step of the supply chain of the optical disc 10. In addition, in the step S36, when the enabling device 40 contacts the transponder 30, the transponder 30 replies to the enabling device 40 with a unique identifier. This identifier characterizes the transponder 30 in a unique, unmistakable manner. Thereafter, in a step S37, the enabling device 40 contacts the authorizing means 60 (e.g. embodied as a licensing authority) and requests the authorizing means 60 for a remote authentication of the transponder 30. As a result, in a step S38, the authorizing means 60 remotely authenticate the transponder 30 with means provided by the store in conjunction with the enabling device 40. To this end, in a step S38, the authorizing means 60 send a challenge and a pre-calculated response to the challenge to the transponder 30.

Thereafter, in a step S39, the transponder 30 determines, similar to the previous embodiments, a response to the challenge and compares the determined response with the pre-calculated response from the authorizing means 60. In a step S40, the transponder 30 communicates to the authorizing means 60 a result of the authentication procedure. In more detail, the transponder 30 communicates to the authorizing means 60 whether the calculated response matches the pre-calculated response from the authorizing means 60 or not. Finally, in a step S41, the authorizing means 60 determine an authenticity status of the transponder 30 and communicate the result of this determination to the enabling device 40 in a step S42. It is obvious, that this embodiment, in order to provide a data connection between the enabling device 40 and the remote arranged authorizing means 60, needs some sort of connectivity (e.g. networking means) between the enabling device 40 and the authorizing means 60. However, this sort of connectivity is not seen as an onerous requirement for most deployments.

In a further preferred embodiment of the present invention, the transponder 30 can preferably comprise additional means to perform a distributed authentication, for example formed as a public key cryptography. Hence, the transponder 30 holds at least one certificate that has been issued by the authorizing means 60. This will improve the execution of the authentication procedure as described in the previous embodiments by enabling the transponder 30 to freely reply to any incoming challenge, and by enabling the rendering devices 50 to obtain a certificate issued by the authorizing means 60. The rendering device 50 can thus verify the authenticity of the transponder 30 in an independent manner.

In a further preferred embodiment of the invention, the rendering device 50 communicates an authenticity status of the transponder 30 by over-impressing in a section of a graphical user interface of the display 55 a symbol such that a well known “authentic”-graphic is displayed, which denotes the authenticity of the media content 90. Said symbol could e.g. be a “black-spot” or a mostly opaque graphic which completely overlaps the position of the aforementioned “authentic” graphic. The symbol can be designed such that, if the “authentic”-graphic has been pre-recorded in a counterfeit media, it will fully over-impose it, thus defeating any attempt to confuse the user.

In a further preferred embodiment of the present invention, the rendering device 50 is able to communicate the status of the transponder 30 by rendering the media content 90 of the optical disc 10 in a resolution depending on a grade of authenticity. This means, that an unauthenticated optical disc 10 can be rendered rendered in a visibly and/or audibly lower resolution than an authenticated optical disc 10.

Advantageously, due to the fact that the transponders 30 can be easily communicated to, it is possible by means of the present invention that the information on the transponders 30 can be retrieved and validated at:
any step of the supply chain,
the point of sale,
check-in/check-out,
or within the customers home, by integrating the RFID reading device 41 ‘with the rendering device 50. As a result, the inclusion of inexpensive transponders 30 on/in the optical discs 10 could enable content providers to manufacture and distribute media content 90 of optical discs 10 that can be easily authenticated against counterfeiting or other forms of misuse.

A further aspect of the present invention can be seen in a method of providing secret keys for authenticating optical discs 10. To this end, the method comprises a step of providing the transponder key KRFID to the transponder 30 which is attached to the optical disc 10. Afterwards, the enabling key KENAB is supplied to the enabling device 40. Thereafter, also the first database 20 with first authentication data 21 is sent to the enabling device 40. At least a subset of the first authentication data 21 can be decrypted by the enabling device 40 using the enabling key KENAB, wherein at least a subset of the first authentication data 21 can be decrypted by the transponder 30 by applying a cryptographic algorithm to the first authentication data 21 using the transponder key KRFID.

A further aspect of the present invention can be seen in a method of providing secret keys for authenticating optical discs 10. To this end, the method provides a step of providing the transponder key KRFID to the transponder 30 which is attached to the optical disc 10. Furthermore, the driver key KDRIV is applied to the rendering device 50. Furthermore, the second database 20 with second authentication data 81 is sent to the optical disc 10. At least a subset of the second authentication data 81 can be decrypted by the rendering device 50 using its driver key KDRIV. At least a subset of the second authentication data 81 can be decrypted by the transponder 30 by applying a cryptographic algorithm to the second authentication data 81 using the transponder key KRFID.

Further, the content key KCONT is applied to the transponder 30 and the session key KSESS is applied to the rendering device 50. By means of the session key KSESS the content key KCONT is capable of being transported from and/or to the transponder 30 securely. The aforementioned secret key KCONT is provided by the authorizing means 60 on a date of an official release of the media content 90 of the optical disc 10.

Finally, it should be noted that the above mentioned preferred embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1-2. (canceled)

3. Method of authenticating optical discs (10) with media content (90) by means of an enabling device (40) and a first database (20) with first authentication data (21), wherein a disc (10) comprises a transponder (30), the method comprising the steps of:
a) Reading and decrypting the first authentication data (21) by the enabling device (40);
b) Requesting a challenge (C1) from the transponder (30) by the enabling device (40);
c) Sending the challenge (C1) to the enabling device (40) by the transponder (30)
d) Finding a response (R1) to the challenge (C1) in the first authentication data (21) by the enabling device (40);
e) Sending the response (R1) to the transponder (30) by the enabling device (40);
f) Determining a response (R2) to the challenge (C1) by the transponder (30); and
g) Checking by the transponder (30) whether the responses (R1, R2) match up.

4. Method according to claim 3, wherein in step a) the first authentication data (21) are decrypted by means of an enabling key (KENAB), the enabling key (KENAB) being arranged on the enabling device (40).

5. Method according to claim 3, wherein in step f) the response (R2) is determined by applying a cryptographic algorithm to the challenge (C1) by using a transponder key (KRFID), the transponder key (KRFID) being arranged on the transponder (30).

6. Method according to 3, wherein the first authentication data (21) comprise a content key (KCONT), the content key (KCONT) being usable for decrypting the media content (90) and a session key (KSESS), the session key (KSESS) being usable for encrypting the content key (KCONT), the method further comprising the steps of:
g) Sending an encrypted content key (KENCR) to the transponder (30) by the enabling device (40);
h) Determining a session key (KSESS) from the challenge (C1) and the transponder key (KRFID) by the transponder (30);
i) Determining a content key (KCONT) by the transponder (30); and
j) Storing the content key (KCONT) on the transponder (30) by the transponder (30).

7. Method according to claim 6, wherein in step h) the session key (KSESS) is determined by applying a cryptographic algorithm to the challenge (C1) using the transponder key (KRFID) and wherein in step i) the content key (KONT) is determined by applying a cryptographic algorithm to the encrypted content key (KENCR) and to the session key (KSESS).

8. Method according to claim 3, wherein an authorizing means (60) is able to send the enabling key (KENAB) to the enabling device (40) and to send the transponder key (KRFID) to the transponder (30).

9. Method according to claim 3, wherein the response (R2) and the session key (KSESS) can be determined from the challenge (C1) by the authorizing means (60), wherein the response (R2) and session key (KSESS) can be stored on the transponder (30) by the authorizing means (60).

10. Method according to claim 3, wherein the optical disc (10) can be rendered by a rendering device (50), the method further comprising the steps of:
Prior to the steps a) to g) increasing the rendering data on the transponder (30) by the rendering device (50);
Storing the rendering data on the transponder (30) by the transponder (30); and
Requesting the rendering data from the transponder (30) by the enabling device (40); wherein the steps a) to g) can be executed in a case where the rendering data are below a defined threshold value.

11. Method according to claim 10, wherein the rendering data on the transponder (30) can be increased by the rendering device (50) at essentially regular intervals during the rendering of the optical disc (10), wherein the rendering device (50) requests the rendering data from the transponder (30), and wherein the rendering device (50) refuses the rendering of the optical disc (10) when the rendering data have reached a defined threshold value.

12. Method according to claim 10, wherein the rendering data on the transponder (30) can be increased by the rendering device (50) at essentially regular intervals during the rendering of the optical disc (10), wherein the rendering device (50) requests the rendering data from the transponder (30), wherein the content key (KCONT) is erasable by the transponder (30) in a case where the rendering data have reached a defined threshold value.

13. Method according to claim 10, wherein an identification of the rendering device (50) can be sent to the transponder (30) during the rendering of the optical disc (10), wherein a number of different rendering devices (50) can be counted by the transponder (30), and wherein in a case where the number of the rendering devices (50) has reached a defined threshold value, the rendering of the optical disc (10) can be stopped by the rendering device (50).

14. Method according to claim 10, wherein an identification of the rendering device (50) can be sent to the transponder (30) during the rendering of the optical disc (10), wherein a number of different rendering devices (50) can be counted by the transponder (30), and wherein in a case where the number of the rendering devices (50) has reached a defined threshold value, the content key (KCONT) can be erased by the transponder (30).

15-24. (canceled)

25. Optical disc (10) comprising media content (90) and a second database (80) with second authentication data (81), wherein the optical disc (10) further comprises a transponder (30), wherein at least a subset of authentication data on the transponder (30) matches cryptographically at least a subset of the second authentication data (81).

26. Optical disc according to claim 25, wherein the second authentication data (81) comprise at least first and second items, wherein each of the first items is related to each of the second items; and wherein the data on the transponder (30) comprise a transponder key (KRFID) by means of which the transponder (30) is able to determine a corresponding second item to a first item from the second authentication data (81).

27. Optical disc according to claim 26, wherein the second database (80) is bound to the content (90) by means of a secure content digest.

28. Optical disc according to claim 25, wherein the optical disc (10) comprises an encrypted media content (90) and wherein the sets of the second authentication data (81) comprise further a session key (KSESS) for transmitting the content key (KCONT) from and to the transponder (30).

29. Optical disc according to claim 25, wherein at least a subset of the sets of the second authentication data (81) is accessible to the rendering device (50) by means of a driver key (KDRIV), the driver key (KDRIV) being arranged on the rendering device (50).

30. Apparatus for rendering an optical disc (10) according to claim 25, wherein the apparatus (50) comprises a driver key (KDRIV), by means of which the apparatus (50) is able to read and decrypt at least a subset of the second authentication data (81).
